(19) United States
(12) Patent Application Publication
(10) Pub. No.: US 2026/0119930 A1
(43) Pub. Date: Apr. 30, 2026

(54) Efficient Approximation of a Circuit Knitting Scheme

(71) Applicant: Dell Products L.P., Round Rock, TX (US)

(72) Inventors: Miguel Paredes QUIÑONES, Campinas (BR); Micael Veríssimo de ARAÚJO, Rio de Janeiro (BR); Rômulo Teixeira de Abreu PINHO, Niterói (BR); João Victor da Fonseca PINTO, Rio de Janeiro (BR)

(21) Appl. No.: 18/926,102

(22) Filed: Oct. 24, 2024

(51) Int. Cl. G06N 10/20; G06N 10/70

(52) U.S. Cl. CPC G06N 10/20; G06N 10/70

(57) ABSTRACT

One example method includes cutting a quantum circuit to generate a set of subcircuits of the quantum circuit, and the quantum circuit is larger than any of the subcircuits, determining a respective fidelity associated with removal of each of the subcircuits from the quantum circuit, ranking the subcircuits according to their respective associated fidelity, simulating each of the subcircuits such that each of the subcircuits generates a respective probability vector, and using the respective probability vectors to inform a knitting process, and the knitting process comprises generating a comparative quantum circuit having a probability vector that approximates, within a specified range, a probability vector of the quantum circuit.

### TECHNOLOGICAL FIELD OF THE DISCLOSURE

Embodiments disclosed herein generally relate to quantum computing. More particularly, at least some embodiments relate to systems, hardware, software, computer-readable media, and methods, for circuit knitting.

### BACKGROUND

Running large quantum circuits is challenging in part because typical quantum computers can only handle a few hundred qubits. To overcome this problem, techniques such as circuit cutting and circuit knitting have been developed. In circuit cutting, a large quantum circuit is divided into subcircuits in an attempt to minimize, or at least reduce, the computational effort relative to what would be required to execute the large quantum circuit as a whole. The results from the execution of each of the subcircuits can then be used to build a final probability vector for the large quantum circuit from which the subcircuits were obtained.

While circuit cutting, and circuit knitting, can be useful, these approaches may present problems of their own. For example, typical circuit cutting processes generate an exponential number of subcircuits for running on the available classical or quantum hardware. As another example, optimizing the execution of a large number of subcircuits in heterogeneous hardware requires knowledge, which may not be readily available or determinable, of the respective contribution of each subcircuit in the approximation of a probability of the larger circuit from which the subcircuits were obtained.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a machine learning (ML) model training scheme, according to one embodiment.

FIG. 2 discloses aspects of a method according to one embodiment.

FIG. 3 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to quantum computing. More particularly, at least some embodiments relate to systems, hardware, software, computer-readable media, and methods, for circuit knitting.

One or more embodiments embrace methods for knitting subcircuits, of a quantum circuit, together. One embodiment comprises a method for training an ML (machine learning) model to predict the fidelity of a quantum circuit portion to an associated larger quantum circuit, where the quantum circuit portion was created by cutting the subcircuit from the associated larger quantum circuit. In this way, the subcircuit(s) with an associated relatively higher fidelity may be knitted together, while possibly omitting any low fidelity subcircuit(s), to create a comparative quantum circuit that approximates, at an acceptable level, a probability, or probability vector, of an output of the entire larger quantum circuit.

Thus, in an embodiment, only a subset, that is, less than all, of the subcircuits obtained from a larger quantum circuit may be needed when a knitting process is performed to create a comparative quantum circuit whose probability approximates, within an acceptable boundary or range, the probability of the original larger quantum circuit. Put another way, not all of the subcircuits obtained from the larger quantum circuit are necessarily required to be employed when a circuit knitting process is performed. As such, the computational effort needed for a knitting process for the comparative quantum circuit, according to one embodiment, is less than would be needed for a knitting process for the original larger quantum circuit upon which the comparative quantum circuit is based.

One embodiment of a method comprises operations including, but not limited to: generating a set of subcircuits from a larger quantum circuit; determining a respective fidelity associated with removal of each of the subcircuits from the larger quantum circuit; ranking the subcircuits according to their associated fidelity; simulating each of the subcircuits; and, using respective probability vectors generated by each of the subcircuits, to inform a knitting scheme that generates a comparative quantum circuit having a probability vector that approximates a probability vector of the larger quantum circuit.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may determine a relative importance of a particular subcircuit to the overall performance of a larger quantum circuit from which the subcircuit was cut. An embodiment may identify a subcircuit whose removal from a larger quantum circuit does not materially affect the probability vector of a quantum circuit portion that resulted when the subcircuit was cut from the larger quantum circuit. An embodiment may reduce, relative to conventional approaches, the number of subcircuits that are knit together to produce a larger quantum circuit from which the subcircuits were initially cut. An embodiment may identify a subcircuit whose removal from a larger quantum circuit does not materially affect the probability vector of the larger quantum circuit. An embodiment may reduce the amount of computing resources needed to knit subcircuits together. Various other advantages of one or more embodiments will be apparent from this disclosure.

### A. Aspects of an Example Context for One Embodiment

The following is a discussion of aspects of an example context for various embodiments. This discussion is not intended to limit the scope of the claims or this disclosure, or the applicability of the embodiments, in any way.

As noted earlier, it is challenging to turn large quantum circuits since current quantum computers can typically only handle hundreds of qubits. To deal with this problem, approaches have been developed for circuit cutting and knitting. In circuit cutting, a large quantum circuit is divided into a group of smaller subcircuits, with the aim of minimizing the computational effort to run the large quantum circuits. The results obtained from running the subcircuits is then used to build the final probability vector of the large quantum circuit.

During a circuit knitting process, the reconstruction of the final probability vector of the large quantum circuit from which the subcircuits done by performing Kronecker delta operations between the results obtained from the execution of the subcircuits. The equation below indicates how this reconstruction may be done:

$$p ( {b}_{1} , … , {b}_{n} … , {b}_{m} ) = \frac{1}{2} {\sum }_{i = 1}^{4} {\sum }_{{b}_{n}^{′} = \{ 0 , 1 \}} {p}_{A}^{i} ( {b}_{1} , … , {b}_{n}^{′} \vert {b}_{n}^{′} ) ⊗ {p}_{B}^{i} ( {b}_{n} , … , {b}_{m} ) ,$$

where

$${p}_{A}^{i}$$

(b₁, . . . , b′ₙ|b′ₙ) is the probability of a measurement of the bitstream (b₀, . . . , bₙ) in a given base i of the decomposition used during the circuit cutting scheme and

$${p}_{B}^{i}$$

(bₙ, . . . , bₘ) is the probability of getting bitstream (bₙ, . . . , bₘ) in the second subcircuit B.

That is, since the original circuit was divided into different quantum subcircuits, every subcircuit creates different subcircuits to continue representing the probability behavior of the original larger circuit. This may be done by creating variations of the original subcircuits in a different basis in a way that the probability vectors of these variations combined with the probability vectors of the rest of the larger subcircuit joined give the original larger probability vector. The reference, above, to the probability of measure the bitstream in a given base is the probability result of one of the subcircuits generated from an original subcircuit. In the illustrative example above, two subcircuits are combined to obtain the result of the original larger circuit.

It is noted that a circuit cutting/knitting scheme permits not only the splitting of a circuit in real quantum computers, but also can be used to split a circuit in simulators, or perform a mix of operations. For example, such a scheme may comprise running part of a quantum circuit in a real quantum hardware, and the other part of the circuit in classical hardware using a quantum simulation method.

Currently, some of the most powerful simulators are those based on tensor networks such as, for example, matrix product state (MPS) simulators, which approximate the solution of the simulation of a circuit by reducing the intermediate dimension of the calculus performed during the simulation. With this approach, it is possible to have approximated simulations with less computational efforts than conventional simulation methods such as, for example, state vector and density matrix approaches.

### B. Detailed Discussion of Aspects of an Example Embodiment

### B.1 Introduction

One example embodiment operates to minimize the computational overhead while using classical simulation of subcircuits in a circuit knitting scheme. One embodiment may obtain a rank of importance of the probability vector of a subcircuit on the final calculation of the probability of the large circuit. Once this rank is obtained, an embodiment may then order which subcircuit must be simulated with more accuracy than others. Here, more important means an exact simulation of a circuit by using a state vector simulator, if available resources, or a tensor network method with a good approximation, for example, not reducing by too much the intermediate dimension obtained from the MPS method. One embodiment comprises includes a dataset generation process and associated dataset, and/or machine learning (ML) training to determine the rank from the circuit and their subcircuits.

### B.2 Example Method

One example embodiment of a method may comprise the operations set forth in the sections below. This example method may be performed by a combination of classical computing hardware and quantum computing hardware. However, no embodiment is limited to performance by any particular type or grouping of computing hardware.

### B.2.1—Phase 1

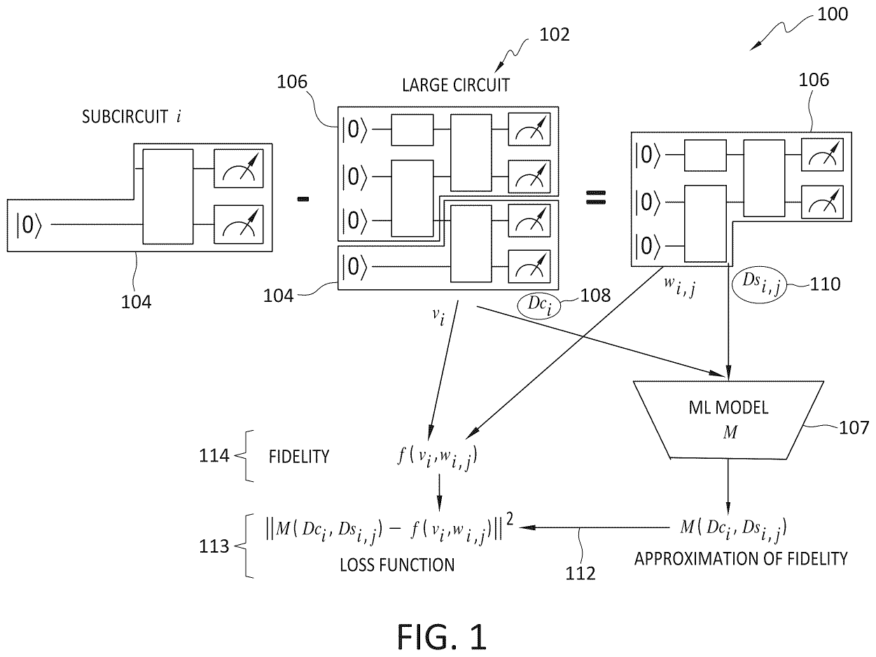

Initially, and with reference now to FIG. 1, an example training schema 100 for a machine learning model M, according to one embodiment, is disclosed that may predict the fidelity between a large quantum circuit and a remaining circuit portion after a subcircuit has been cut from the large quantum circuit.

It is noted that as used herein, “fidelity” is a measurement of an extent to which a larger quantum circuit is affected by removal or cutting of a particular subcircuit—such that if a subcircuit is removed, and the probability vector of the remaining portion of the larger quantum circuit is materially unchanged, then that subcircuit is associated with a relatively low fidelity—that is, its presence/absence in/from the larger quantum circuit has relatively little influence on the probability vector of the larger quantum circuit.

In more detail, “fidelity” is defined as set forth in the following reference: https://en.wikipedia.org/wiki/Fidelity_of_quantum_states. That is, fidelity is a distance between two distributions. If the resulting probability vector comes from a subcircuit with low importance, then the fidelity between the original large circuit and the modified circuit will be high, possibly near 1 in some cases. On the other hand, if the extracted subcircuit significantly influences the last probability of the original larger circuit, then the fidelity will be lower, possibly near 0 in some cases. As these examples illustrate, fidelity is defined as having a value in the range of 0 to 1, inclusive. In an embodiment, subsections of this interval may be arbitrarily defined, and used to define low and high fidelity, taking into account that fidelity values near to 0 are low and fidelity values near to 1 are high.

In the example schema 100, one or more large circuits Cᵢ 102 may be randomly generated. Likewise, subcircuits 104 and 106 of the large circuit(s) 102 may be randomly generated. In more detail, an embodiment may generate subcircuits S_{i,j}, where j is in the set of subcircuits index Ωᵢ of circuit Cᵢ.

Next, an embodiment may collect a directed acyclic graph representation (DAG) of both circuits 104 and 106 in, respectively, Dcᵢ and Ds_{i,j}, where the nodes and edges of this DAG representation contain pointers that characterize the position of the subcircuit 104 or 106 on the large circuit 102, from which the subcircuits 104 and 106 were taken, by numbering nodes and edges with same id on both DAGs.

As well, an embodiment may classically simulate circuit Cᵢ 102, obtain a state vector vᵢ for circuit Cᵢ 102, and then simulate circuit S′_{i,j} 106, which is the large circuit Cᵢ 102 without gates on S_{i,j}, and obtain w_{i,j}. An embodiment may then use a measurement of divergence between both vectors, as in example fidelity f(vᵢ,w_{i,j}). This measurement of fidelity provides a way to measure how, that is, to what extent, the extraction of subcircuit S_{i,j} 104 from circuit Cᵢ 102 modifies the final state vector v; of the circuit C; 102.

In an embodiment, a simulator may be used to classically simulate a circuit. In the example above, a classical simulator may be used that calculates a final state vector, which is a complex vector that contains the amplitudes of every possible state. Mathematically, the (1) state vector multiplied by (2) the complex conjugate gives (3) the probability vector.

A requirement as to the relative closeness, or fidelity, in any given case between an approximated probability vector and an actual or expected probability vector for a circuit may depend on the type of problem that the original large circuit is intended to solve. For example, there are problems that requires a good precision for being solved by a quantum circuit. An article https://www.frontiersin.org/journals/physics/articles/10.3389/fphy.2022.893507/full discusses the level of qubit fidelity and gives some examples as having better than 99.9% of fidelity, so then for circuit fidelity, something like this fidelity may be expected as well, in some cases at least.

### B.2.2—Phase 2

With data collected in phase 1 of an example method, discussed above, an ML model M(·) 107 may be trained that receives, as inputs, both DAGs Dcᵢ 108 and Ds_{i,j} 110 and the output 112 of the model M(·) 107 approximates the fidelity f(vᵢ,w_{i,j}). Then, in one embodiment, the loss function 113 will be:

$${\sum }_{i , j ∈ {Ω}_{i}} {‖ M ( {Dc}_{i} , {Ds}_{i , j} ) - f ( {v}_{i} , {w}_{i , j} ) ‖}^{2}$$

### B.2.3—Phase 3

In this phase, the model M(·) 107 is used to predict the relative importance of a subcircuit \tilde{S}_{i,j}, such as the subcircuit 104 for example, of large circuit \tilde{C}ᵢ, such as the large circuit 102 for example, by predicting the fidelity f(\tilde{v}ᵢ,\tilde{w}_{i,j}) 114. If relatively lower fidelity values are obtained by M(·) 107 for a given subcircuit \tilde{S}_{i,j}, that will indicate that such subcircuit \tilde{S}_{i,j} is relatively unimportant, that is, relative to one or more of the other subcircuit(s) of the large circuit Cᵢ. Thus, the respective fidelity values associated with one or more subcircuits may be used, in one embodiment, to create a ranking R of subcircuits. That is, the subcircuits may be ranked according to their respective fidelity values.

### B.2.4—Phase 4

In phase 4, the subcircuit ranking R generated in phase 3 may be used to decrease the precision of the simulations of subcircuits \tilde{S}_{i,j}. For example, MPS simulators are being used, an embodiment may create a table of latent dimensions D_{i,j} for every subcircuit \tilde{S}_{i,j}. In one embodiment, this may be done arbitrarily by setting a minimum dimension required for a circuit to be simulated, where this dimension is related to the precision. In more detail, the latent dimension can be thought of as indicating a level of approximation of an MPS simulator. The latent dimension, which may comprise an integer number of dimensions, may then be correlated and the precision approximation that can be given by a determined measurement, for example, the latent dimension may be expressed as (1-fidelity). Thus, for a fidelity of 0.9 for example, the latent dimension would be (1-0.9), or 0.1.

Another option is combining different simulation methods and real hardware where circuits with a high rank can be simulated by using one of (1) the MPS with full precision, (2) a state vector simulator with enough resources to run it, or (3) real quantum hardware. On the other hand, circuits with low rank can be executed exclusively by simulators, such as a low precision MPS for example, with relatively low, compared to the aforementioned options (1), (2), and (3), accuracy.

In more detail, in the context of a Matrix Product State (MPS) simulator for quantum computing, the latent dimension refers to the bond dimension, or the maximum number of states that can be entangled between adjacent sites in the MPS representation. This dimension is important because it determines the amount of entanglement the MPS can capture, and thus affects the accuracy and efficiency of the simulation.

Thus, for example, a higher latent dimension enables the MPS to represent more complex quantum states with higher entanglement, but it also increases the computational resources required for the simulation. Conversely, a lower latent dimension reduces computational demands but may limit the accuracy of the simulation for highly entangled states.

### B.2.5—Phase 5

Finally, respective probability vectors \tilde{w}_{i,j} obtained from the simulation of every subcircuit \tilde{S}_{i,j} may be used in a circuit knitting scheme to obtain the approximate probability vector of the larger circuit \tilde{v}ᵢ from which those subcircuits \tilde{S}_{i,j}. In an embodiment, a threshold may be specified to be used as a basis for determining whether or not the approximate probability vector is acceptably close to a final state vector of the original large quantum circuit from which the subcircuit(s) were cut. In an embodiment, because only the subcircuits with relatively high fidelity are used in this circuit knitting scheme, the probability vector of the larger circuit \tilde{v}ᵢ may be relatively close to the final state vector.

### C. Aspects of Another Example Method According to One Embodiment

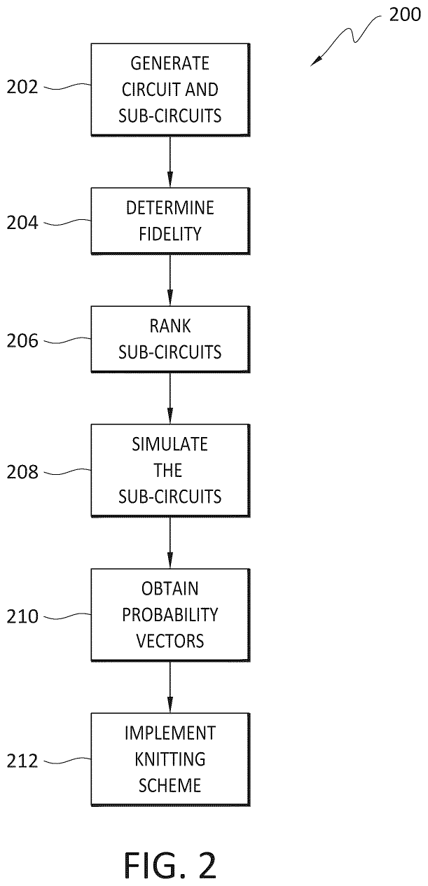

With attention now to FIG. 2, a method according to one embodiment is indicated at 200. The example method may begin by generating a set of subcircuits 202 from a larger quantum circuit. Next, a respective fidelity associated with removal of each of the subcircuits from the larger quantum circuit is determined 204. The subcircuits may then be ranked 206 according to fidelity. A subset, or all, of the subcircuits may then be simulated, that is, executed 208. In an embodiment, only those subcircuits whose associated fidelity exceeds a threshold may be executed 208. Thus, in an embodiment, only a subset, but not all, of the subcircuits may be executed 208. Execution 208 of the subcircuits may result in generation 210 of a respective probability vectors by each of the subcircuits. Finally, a knitting scheme may be performed 212, using the probability vectors, to generate a comparative quantum circuit having a probability vector that approximates a probability vector of the larger quantum circuit from which the subcircuits were initially cut.

The comparative quantum circuit may thus be obtained with relatively less computational load than would be required to execute the original larger quantum circuit, while also providing an output probability vector that is acceptably close to the probability vector of the original larger quantum circuit. That is, comparable performance may be obtained with lower computing resources demand.

### D. Further Discussion

As disclosed herein, one or more embodiments may possess various useful features and aspects, although no embodiment is required to possess any of such features and aspects. The following examples are illustrative, but not exhaustive. An embodiment may comprise a schema and method for determining a relative importance of a contribution of a subcircuit probability vector on a large circuit probability vector. An embodiment may comprise a method for ranking simulations of subcircuits in a circuit knitting scheme.

### E. Further Aspects of One or More Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.
Embodiment 1. A method, comprising: cutting a quantum circuit to generate a set of subcircuits of the quantum circuit, and the quantum circuit is larger than any of the subcircuits; determining a respective fidelity associated with removal of each of the subcircuits from the quantum circuit; ranking the subcircuits according to their respective associated fidelity; simulating each of the subcircuits such that each of the subcircuits generates a respective probability vector; and using the respective probability vectors to inform a knitting process, and the knitting process comprises generating a comparative quantum circuit having a probability vector that approximates, within a specified range, a probability vector of the quantum circuit.
Embodiment 2. The method as recited in claim 1, wherein the cutting comprises a series of cutting processes, and each of the cutting processes is performed in turn to generate a respective one of the subcircuits.
Embodiment 3. The method as recited in claim 1, wherein, for a given one of the subcircuits, the fidelity associated with that given subcircuit comprises a measure of a distance between a probability vector of the quantum circuit before that given subcircuit has been cut, and a probability vector of the quantum circuit after the given subcircuit has been cut.
Embodiment 4. The method as recited in claim 1, wherein the knitting process comprises knitting fewer than all of the subcircuits together to form the comparative quantum circuit.
Embodiment 5. The method as recited in claim 1, wherein the respective fidelity of subcircuits used in the knitting process is greater than the respective fidelity of the subcircuit(s) omitted from the knitting process.
Embodiment 6. The method as recited in claim 1, wherein the fidelity of one of the subcircuits indicates a relative importance of a contribution of that one subcircuit to the probability vector of the quantum circuit.
Embodiment 7. The method as recited in claim 1, wherein each of the probability vectors of the subcircuits corresponds to a respective fidelity.
Embodiment 8. The method as recited in claim 1, wherein a computational effort to perform the knitting is less than a computational effort that would be required to knit all of the subcircuits.
Embodiment 9. The method as recited in claim 1, wherein the respective fidelity associated with each of the subcircuits is determined based on a fidelity approximation generated by an ML (machine learning) model, and using a loss function that is applied to the fidelity approximation.
Embodiment 10. The method as recited in claim 1, wherein one of the subcircuits is simulated on an MPS (matrix product state) simulator.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

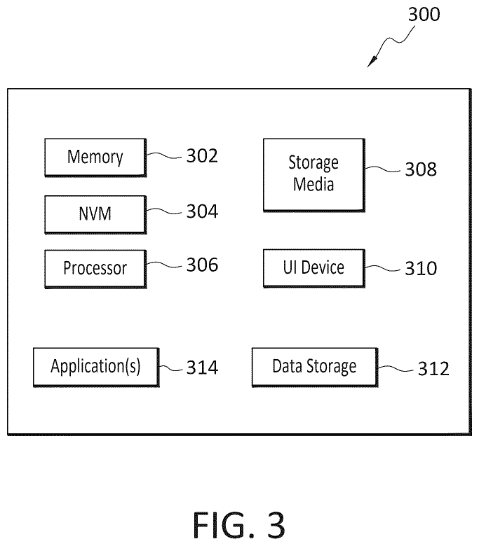

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
cutting a quantum circuit to generate a set of subcircuits of the quantum circuit, and the quantum circuit is larger than any of the subcircuits;
determining a respective fidelity associated with removal of each of the subcircuits from the quantum circuit;
ranking the subcircuits according to their respective associated fidelity;
simulating each of the subcircuits such that each of the subcircuits generates a respective probability vector; and
using the respective probability vectors to inform a knitting process, and the knitting process comprises generating a comparative quantum circuit having a probability vector that approximates, within a specified range, a probability vector of the quantum circuit.

2. The method as recited in claim 1, wherein the cutting comprises a series of cutting processes, and each of the cutting processes is performed in turn to generate a respective one of the subcircuits.

3. The method as recited in claim 1, wherein, for a given one of the subcircuits, the fidelity associated with that given subcircuit comprises a measure of a distance between a probability vector of the quantum circuit before that given subcircuit has been cut, and a probability vector of the quantum circuit after the given subcircuit has been cut.

4. The method as recited in claim 1, wherein the knitting process comprises knitting fewer than all of the subcircuits together to form the comparative quantum circuit.

5. The method as recited in claim 1, wherein the respective fidelity of subcircuits used in the knitting process is greater than the respective fidelity of the subcircuit(s) omitted from the knitting process.

6. The method as recited in claim 1, wherein the fidelity of one of the subcircuits indicates a relative importance of a contribution of that one subcircuit to the probability vector of the quantum circuit.

7. The method as recited in claim 1, wherein each of the probability vectors of the subcircuits corresponds to a respective fidelity.

8. The method as recited in claim 1, wherein a computational effort to perform the knitting is less than a computational effort that would be required to knit all of the subcircuits.

9. The method as recited in claim 1, wherein the respective fidelity associated with each of the subcircuits is determined based on a fidelity approximation generated by an ML (machine learning) model, and using a loss function that is applied to the fidelity approximation.

10. The method as recited in claim 1, wherein one of the subcircuits is simulated on an MPS (matrix product state) simulator.

11. A non-transitory storage medium having stored therein instructions that are executable by one or more hardware processors to perform operations comprising:
cutting a quantum circuit to generate a set of subcircuits of the quantum circuit, and the quantum circuit is larger than any of the subcircuits;
determining a respective fidelity associated with removal of each of the subcircuits from the quantum circuit;
ranking the subcircuits according to their respective associated fidelity;
simulating each of the subcircuits such that each of the subcircuits generates a respective probability vector; and
using the respective probability vectors to inform a knitting process, and the knitting process comprises generating a comparative quantum circuit having a probability vector that approximates, within a specified range, a probability vector of the quantum circuit.

12. The non-transitory storage medium as recited in claim 11, wherein the cutting comprises a series of cutting processes, and each of the cutting processes is performed in turn to generate a respective one of the subcircuits.

13. The non-transitory storage medium as recited in claim 11, wherein, for a given one of the subcircuits, the fidelity associated with that given subcircuit comprises a measure of a distance between a probability vector of the quantum circuit before that given subcircuit has been cut, and a probability vector of the quantum circuit after the given subcircuit has been cut.

14. The non-transitory storage medium as recited in claim 11, wherein the knitting process comprises knitting fewer than all of the subcircuits together to form the comparative quantum circuit.

15. The non-transitory storage medium as recited in claim 11, wherein the respective fidelity of subcircuits used in the knitting process is greater than the respective fidelity of the subcircuit(s) omitted from the knitting process.

16. The non-transitory storage medium as recited in claim 11, wherein the fidelity of one of the subcircuits indicates a relative importance of a contribution of that one subcircuit to the probability vector of the quantum circuit.

17. The non-transitory storage medium as recited in claim 11, wherein each of the probability vectors of the subcircuits corresponds to a respective fidelity.

18. The non-transitory storage medium as recited in claim 11, wherein a computational effort to perform the knitting is less than a computational effort that would be required to knit all of the subcircuits.

19. The non-transitory storage medium as recited in claim 11, wherein the respective fidelity associated with each of the subcircuits is determined based on a fidelity approximation generated by an ML (machine learning) model, and using a loss function that is applied to the fidelity approximation.

20. The non-transitory storage medium as recited in claim 11, wherein one of the subcircuits is simulated on an MPS (matrix product state) simulator.
